(19) United States
(12) Patent Application Publication
(10) Pub. No.: US 2026/0067551 A1
(43) Pub. Date: Mar. 5, 2026

(54) Mobile Device With Mirror

(71) Applicant: Mark Wolf, Brooklyn, NY (US)

(72) Inventor: Mark Wolf, Brooklyn, NY (US)

(21) Appl. No.: 18/965,422

(22) Filed: Dec. 2, 2024

Related U.S. Application Data
(60) Provisional application No. 63/690,107, filed on Sep. 3, 2024.

(51) Int. Cl. H04N 23/55; G02B 1/04; G06F 1/16; H04N 23/51; H04N 23/62

(52) U.S. Cl. CPC H04N 23/55; G02B 1/04; G06F 1/1686; H04N 23/51; H04N 23/62

(57) ABSTRACT

A mobile device. A housing configured to enclose and protect internal components; a display screen mounted on the housing for presenting visual information to a user; and a processor disposed within the housing and operatively connected to the display screen, the processor configured to execute instructions and process data. A memory operatively connected to the processor, the memory configured to store data and executable instructions. A communication module operatively connected to the processor, the communication module configured to enable wireless communication with external devices. An input interface operatively connected to the processor, the input interface configured to receive user inputs. A power source disposed within the housing and operatively connected to the processor, the power source configured to supply electrical power to the mobile device; and a mirror configured along an outer surface of the housing.

### PRIORITY CLAIM

This non-provisional patent application claims the benefit of U.S. Provisional Application No. 63/690,107 filed on Sep. 3, 2024, the entirety of which is incorporated herein by reference.

### FIELD

The present disclosure relates generally to mobile devices. More particularly, the present disclosure relates to a mobile device like a smartphone, a tablet, or other similar handheld device. The present disclosure pertains to the innovative use of a mobile device, such as a smartphone, that incorporates a reflective surface, akin to a mirror. The present disclosure leverages the reflective surface to enhance the functionality of the mobile device, providing users with a convenient and versatile tool for various applications. The reflective surface can be utilized for personal grooming, augmented reality experiences, and improved camera functionalities, among other uses. This integration aims to offer a seamless and multifunctional user experience, combining traditional mobile device capabilities with the practical benefits of a mirror.

### BACKGROUND

Traditional mobile devices, such as smartphones, lack integrated reflective surfaces. This can limit their functionality in certain scenarios. Users often need to carry separate mirrors for personal grooming or rely on the front-facing camera, which can be cumbersome and less effective.

In contrast, a mobile device equipped with an integrated reflective surface offers significant advantages. It provides users with a convenient tool for personal grooming, eliminating the need for additional accessories. This integration not only enhances user convenience but also expands the potential applications of the mobile device, making it a more versatile and valuable tool in everyday life.

### SUMMARY

According to an exemplary arrangement, a mobile device, comprising a housing configured to enclose and protect internal components; a display screen mounted on the housing for presenting visual information to a user; a processor disposed within the housing and operatively connected to the display screen, the processor configured to execute instructions and process data; a memory operatively connected to the processor, the memory configured to store data and executable instructions; a communication module operatively connected to the processor, the communication module configured to enable wireless communication with external devices; an input interface operatively connected to the processor, the input interface configured to receive user inputs; a power source disposed within the housing and operatively connected to the processor, the power source configured to supply electrical power to the mobile device; and a mirror configured along an outer surface of the housing.

In one arrangement, wherein the housing comprises a friction fit for securing the mirror to the housing.

In one arrangement, the friction fit of the housing removably secures the mirror to the housing.

In one arrangement, the friction fit of the housing comprises a first slot and a second slot parallel to the first slot, the first slot and the second slot configured so that the mirror can slide into the first slot and the second slot.

In one arrangement, the mirror is configured to removably slide into the first slot and the second slot.

In one arrangement, the mobile device further comprising a fastener configured to contain the mirror on the housing.

In one arrangement, the fastener comprises a clip configured substantially perpendicular to the first slot and the second slot.

In one arrangement, the mirror further comprises a hinged mechanism for hingedly coupling the mirror to the housing.

In one arrangement, the mirror comprises a flex mirror.

In one arrangement, the flex mirror comprises a polymer mirror.

In one arrangement, the mirror comprises a mirrored film.

In one arrangement, the mobile device further comprising an illuminating device configured along an outer surface of the housing.

In one arrangement, the illuminating device is operatively configured to provide illumination to a surface of the mirror.

In one arrangement, the mobile device comprises a smartphone.

In one arrangement, the mobile device comprises a mobile computing device.

In one arrangement, the mobile computing device comprises a tablet computing device.

In one arrangement, the mobile device further comprising a cover configured to protect the mirror when the mirror is not in use.

In one arrangement, the housing comprises a front surface and a back surface, the back surface comprising a camera and the mirror.

In one arrangement, the mobile device further comprising a magnet for coupling the mirror to the housing.

In one arrangement, the mobile device further comprising a suction device for coupling the mirror to the housing.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an exemplary illustration of a mobile device, according to one arrangement;

FIG. 2 illustrates another exemplary illustration of a mobile device, according to one arrangement;

FIG. 3 illustrates another exemplary illustration of a mobile device, according to one arrangement; and

FIG. 4 illustrates a block diagram of various components of a mobile device, such as the mobile device illustrated in FIGS. 1-3.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

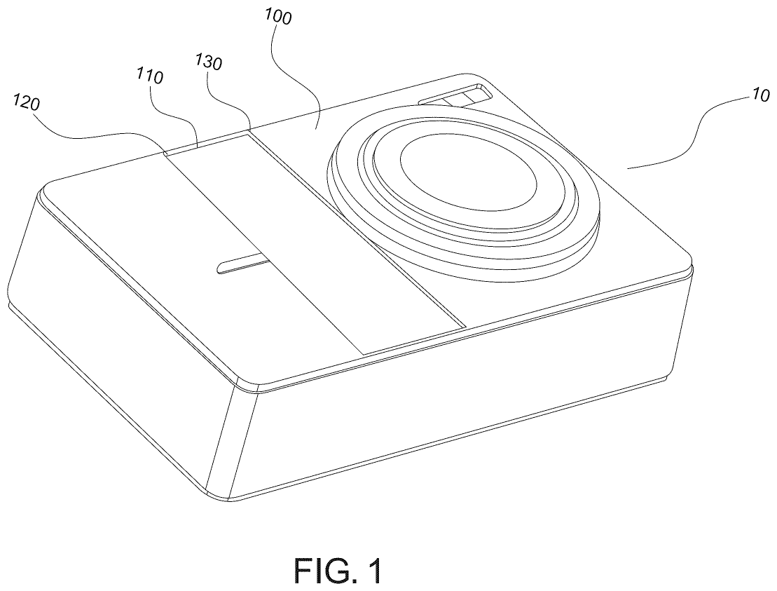

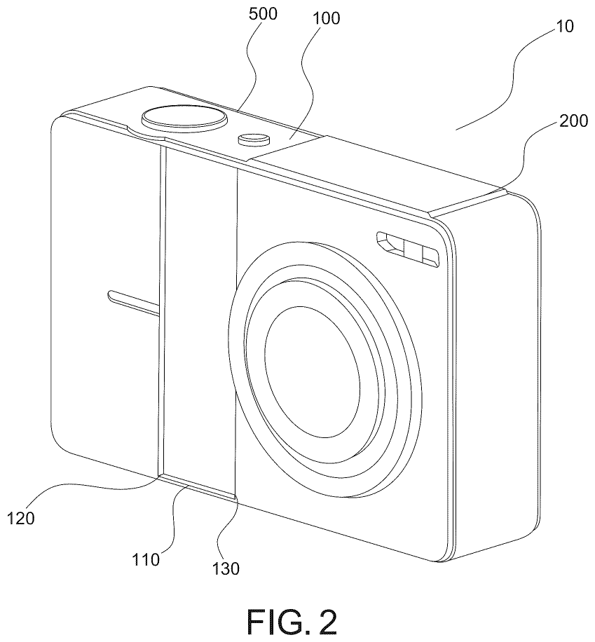

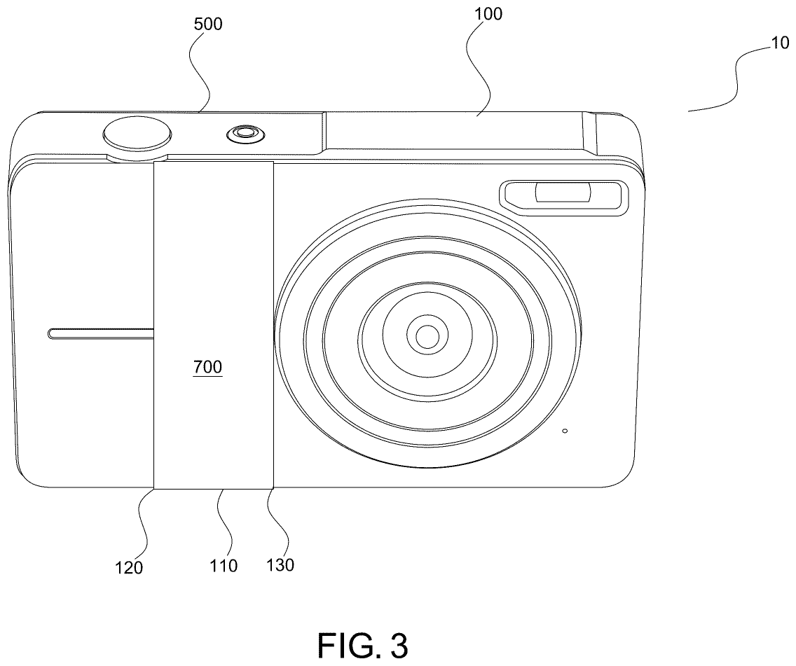

FIG. 1 illustrates an exemplary illustration of a mobile device 10, according to one arrangement. Such a mobile device 10 may comprises a smart phone, a tablet, a computing device or other similar type of device. FIGS. 2 and 3 provide alternative illustrated arrangements of the exemplary mobile device 10. As illustrated, the mobile device 10 comprises a smart phone.

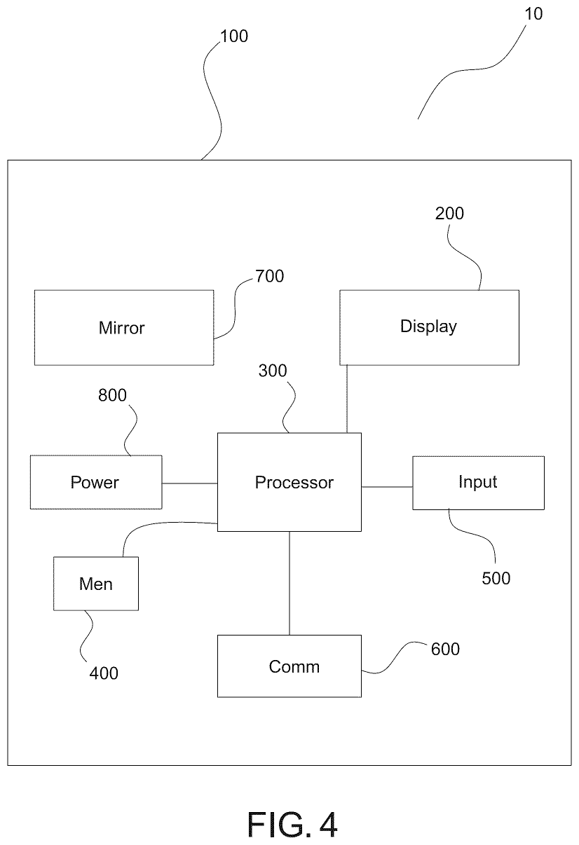

FIG. 4 illustrates a block diagram of various component parts of a mobile device according to one arrangement, such as the mobile device illustrated in FIGS. 1-3.

For example, the block diagram illustrates a housing 100, a display screen 200, a processor 300, a memory 400, an input 500, a communications module 600, and a mirror 700.

### Housing 100

Referring now to FIGS. 1-4, the housing 100 serves as the structural framework of the mobile device 10, designed to enclose and protect all internal components. It ensures the durability and integrity of the device 10, shielding sensitive parts from physical damage, dust, and moisture. In one preferred arrangement, the housing 100 is configured to removably or non-removably contain a reflective surface, like the mirror 700.

For examples, such a housing 100 can be made from a variety of materials, each offering certain benefits. Aluminum is a popular choice due to its lightweight nature and durability. It provides a sleek, premium feel and excellent heat dissipation. Polycarbonate is another common material, known for its impact resistance and flexibility, making it ideal for rugged smartphones. Glass is often used for its aesthetic appeal and smooth finish, allowing for wireless charging capabilities, though it can be more fragile. Ceramic offers a luxurious feel and is highly scratch-resistant, though it can be more expensive and heavier. Lastly, carbon fiber is used for its strength and lightweight properties, providing a high-tech look and feel while being extremely durable. Each material contributes to the overall functionality and design of the mobile device housing 100.

### Display Screen 200

In one preferred arrangement, the display screen 200 is mounted on the housing 100. For example, the display screen 200 can present certain visual information to the user of the mobile device 10. In one arrangement, it is operably coupled to the processor 300. The processor 300 may be configured to send processed data to be displayed. In one arrangement, the display screen 200 comprises a touch-sensitive interface, allowing users to interact directly with the device through touch inputs.

### Processor 300

In one preferred arrangement, the processor 300 comprises the central unit that executes instructions and processes data. As illustrated, the processor 300 is operably coupled to the display screen 200, the memory 400, the communication module 600, and the input interface 500. In one preferred arrangement, the processor 300 interprets user inputs, runs applications, and manages data flow between components, ensuring smooth operation.

For example, in one arrangement, the processor 300 may comprise a processor such as that used in certain smartphones and generally referred to as the Qualcomm Snapdragon series. This is a processor generally known for its high performance and efficiency. The processor, or SoC (System on Chip), integrates the CPU, GPU, and other essential components. It works closely with the memory (RAM and storage) 400 to quickly access and process data, ensuring smooth multitasking and application performance. The processor 300 also interfaces with human interface devices 500 as herein described like the touchscreen, interpreting touch inputs and gestures to provide a responsive user experience.

Additionally, this processor 300 can manage communication with other components such as the camera, sensors, and communication modules (Wi-Fi, Bluetooth) 600, coordinating their functions to deliver a seamless and integrated smartphone experience. This integration allows for efficient power management and optimized performance across all tasks.

### Memory 400

As illustrated, the memory 400 stores data and executable instructions. It is operably coupled to the processor, providing the memory 400 with certain necessary information to execute certain tasks. In one preferred arrangement, the memory 400 holds or stores the operating system, applications, and user data, enabling quick access and efficient processing.

The exemplary mobile device or smartphone 10 may use various types of memory to store data and execute tasks. These different types of memory that may be used in the exemplary mobile device 10 are summarized below.

### Non-Removable Memory (Internal Storage)

Flash Memory (NAND Flash): This is the primary storage used in smartphones. It is non-volatile, meaning it retains data even when the device is powered off. NAND flash memory is fast and reliable, making it ideal for storing the operating system, applications, and user data.

EEPROM (Electrically Erasable Programmable Read-Only Memory): EEPROM is used for storing small amounts of data that must be saved when power is removed, such as firmware and configuration settings. It is slower than NAND flash but offers the advantage of being reprogrammable.

### Removable Memory

MicroSD Cards: These are small, removable memory cards that can be inserted into the smartphone 10 to expand its storage capacity. They are available in various capacities, ranging from a few gigabytes (GB) to several terabytes (TB). MicroSD cards are convenient for storing media files, such as photos, videos, and music.

### Volatile Memory (RAM)

DRAM (Dynamic Random-Access Memory): This type of memory is used for temporary data storage while the smartphone 10 is in use. It is volatile, meaning it loses data when power is turned off. DRAM is crucial for multitasking and running applications smoothly. The more RAM the smartphone 10 has, the better it can handle multiple apps and processes simultaneously.

### Non-Volatile Memory

ROM (Read-Only Memory): ROM is used to store the smartphone's firmware, which includes the bootloader and system software. It is non-volatile and cannot be easily modified by the user. ROM ensures that the device 10 can boot up and operate correctly.

NOR Flash: This type of flash memory is used for storing firmware and boot code. It offers fast read speeds and is reliable for storing critical system data.

### Storage Capacity Types

eMMC (Embedded MultiMediaCard): eMMC is a type of flash storage used in budget and mid-range smartphones. It integrates the memory controller and NAND flash memory into a single package. eMMC is slower than UFS but still provides adequate performance for everyday tasks.

UFS (Universal Flash Storage): UFS is a newer and faster type of flash storage used in high-end smartphones. It offers higher data transfer speeds and better performance compared to eMMC. UFS is ideal for tasks that require quick access to large amounts of data, such as 4K video recording and gaming.

### Communication Module 600

Returning to FIG. 4, the mobile device 10 in one arrangement further comprises a communication module 600. This communication module 600 can enable wireless communication with external devices, such as other smartphones, Wi-Fi networks, and Bluetooth devices. It is connected or operably coupled to the processor 300, which as previously described manages (among other possible computing tasks) data transmission and reception. In one preferred arrangement, the communication module 600 allows the mobile device 10 to connect to the internet, make calls, and exchange data wirelessly.

An overview of the different types of communication modules 600 that may be used in the illustrated mobile device 10 are summarized below.

Bluetooth Classic: Used for connecting to a wide range of devices like headphones, speakers, and car systems. It supports data transfer and audio streaming.

Bluetooth Low Energy (BLE): Designed for applications that require low power consumption, such as fitness trackers and smartwatches. BLE is ideal for devices that need to maintain a long battery life.

Wi-Fi 4 (802.11n): Provides moderate speed and range, suitable for general internet browsing and streaming.

Wi-Fi 5 (802.11ac): Offers higher speeds and better performance, especially in crowded networks. It supports faster data transfer rates and improved connectivity.

Wi-Fi 6 (802.11ax): The latest standard, providing even higher speeds, better efficiency, and improved performance in dense environments. It supports multiple devices simultaneously with reduced latency.

2G (GSM): Basic voice and text communication with limited data capabilities.

3G (UMTS/CDMA): Enhanced data speeds for web browsing and basic internet use.

4G LTE: High-speed data transfer, supporting HD video streaming, online gaming, and fast web browsing.

5G: The newest generation, offering ultra-fast data speeds, low latency, and the ability to connect many devices simultaneously. It supports advanced applications like augmented reality (AR) and virtual reality (VR).

NFC: Enables short-range communication between devices. It is commonly used for contactless payments, data exchange, and pairing devices quickly.

GPS: Provides location services by communicating with satellites. It is essential for navigation, location-based services, and mapping applications.

IR Blaster: Allows the smartphone 10 to function as a remote control for various electronic devices like TVs, air conditioners, and home entertainment systems.

Zigbee: A low-power, low-data rate wireless communication standard used for smart home devices and IoT (Internet of Things) applications.

Z-Wave: Similar to Zigbee, it is used for home automation and IoT devices, providing reliable and secure communication.

UWB: A short-range wireless communication protocol that provides precise location tracking and high data transfer rates. It is used for applications like digital car keys and indoor navigation.

The communication module 600 can play a crucial role in enhancing the functionality and connectivity of a mobile device 10, enabling this device 10 to interact with a wide range of devices and networks.

### Input Interface 500

Referring back to FIGS. 1-4, the mobile device further comprises an input interface 500. In one preferred arrangement, the input interface 500 comprises one or more components such as touchscreens, buttons, and microphones, which receive user inputs. As illustrated, the input interface 500 is operatively coupled to the processor 300, which interprets these inputs and executes corresponding actions. In one preferred arrangement, the input interface 500 allows users to interact with the device 10, navigate menus, and control functions.

The presently disclosed mobile devices 10 use a variety of human interface devices (HIDs) 500 to enable user interaction. Below is an overview of the different types of HIDs 500 that may be used in mobile device 10 illustrated in FIGS. 1-4.

Capacitive Touchscreen: The most common type, it detects touch through the electrical properties of the human body. It supports multi-touch gestures, allowing for pinch-to-zoom, swiping, and other gestures.

Resistive Touchscreen: Less common in modern smartphones, it detects touch through pressure applied to the screen. It can be used with a stylus or finger but does not support multi-touch.

Power Button: Used to turn the device on/off and wake it from sleep mode.

Volume Buttons: Adjust the audio levels for calls, media, and notifications.

Home Button: Found on some smartphones, it provides quick access to the home screen and may include a fingerprint sensor for biometric authentication.

Side Buttons: Additional buttons that can be customized for various functions, such as launching the camera or activating voice assistants.

Mute Switch: Found on some smartphones, it allows users to quickly mute or unmute the device.

Rotary Knobs: Rare in smartphones but can be found in some specialized devices for adjusting settings like volume or brightness.

### Graphical User Interface (GUI)

Icons and Widgets: Visual elements on the home screen and app drawer that provide quick access to applications and information.

Virtual Keyboards: On-screen keyboards that appear when text input is needed. They can be customized with different layouts and languages.

Navigation Gestures: Swipe and tap gestures used to navigate the operating system, switch between apps, and access settings.

Notification Shade: A pull-down menu that displays notifications, quick settings, and shortcuts.

### Biometric Sensors

Fingerprint Scanner: Integrated into the home button, power button, or under the display, it allows for secure authentication and unlocking of the device.

Face Recognition: Uses the front-facing camera and advanced algorithms to recognize the user's face for unlocking the device and authorizing transactions.

Iris Scanner: Uses infrared light to scan the unique patterns in the user's iris for secure authentication.

### Stylus Input

Active Stylus: A pen-like device that communicates with the touchscreen to provide precise input, pressure sensitivity, and additional functionality like buttons for shortcuts.

Passive Stylus: A simple pen-like device that works with capacitive touchscreens but lacks advanced features like pressure sensitivity.

### Voice Input

Microphone: Captures voice commands for virtual assistants like Siri, Google Assistant, and Alexa. It also enables voice typing and voice search.

Voice Assistants: Software that interprets voice commands to perform tasks, answer questions, and control smart home devices.

### Haptic Feedback

Vibration Motor: Provides tactile feedback to simulate the sensation of pressing physical buttons or to alert the user through vibrations.

### Power Source 800

The power source 800, typically a rechargeable battery, supplies electrical power to the mobile device. It is connected to the processor 300 and other components, ensuring they receive the necessary power to function. The power source 800 enables the device 10 to operate independently of external power supplies.

The mobile devices 10 as disclosed herein can use various types of power sources to ensure they operate efficiently and meet user needs. Provided below is a general overview of the different types of power sources that may be used in various arrangements.

### Lithium-Ion (Li-Ion) Batteries

The most common type of battery used in modern smartphones. Li-Ion batteries are known for their high energy density, lightweight, and long lifespan. They provide a high energy density allows for longer battery life. They are also lightweight and compact, making them ideal for slim smartphone designs. They also have a low self-discharge rate, meaning they retain charge well when not in use.

### Lithium-Polymer (Li-Po) Batteries

These are similar to Li-Ion batteries but use a polymer electrolyte instead of a liquid one. They can be molded into various shapes and sizes. They process a Flexible form factor allows for innovative smartphone designs. Generally safer and less prone to leaking compared to Li-Ion batteries. Lightweight with a high energy density.

### Replaceable Batteries

These batteries that can be easily removed and replaced by the user. This design was more common in older smartphones. Users can carry spare batteries and replace them when needed, extending the device's usage time. Easier to replace a degraded battery without needing professional assistance.

### Nickel-Metal Hydride (NiMH) Batteries

An older type of rechargeable battery that was used in early mobile phones. More environmentally friendly compared to older nickel-cadmium (NiCd) batteries. Can be recharged many times without significant memory effect.

### Mirror 700

The mirror 700 is configured along an outer surface of the housing 100. It provides a reflective surface for personal grooming and other uses. In one preferred arrangement, the mirror 700 does not directly interact with the internal electronic components but enhances the device's functionality by offering an additional practical feature.

In one arrangement, as illustrated in FIGS. 1-3, the housing 100 comprises a friction fit 110 for securing the mirror to the housing. For example, in one arrangement, the friction fit 110 of the housing removably secures the mirror 700 to the housing 100 (FIG. 3). In such an arrangement, a user can remove and reinstall the mirror 700 to the housing 100, for example, in the event the mirror 700 is no longer desired or is damaged and needs replacement.

In one arrangement, and as illustrated in FIGS. 1-3, the friction fit of the housing comprises a first slot 120 and a second slot 130 wherein the second slot 130 is parallel to the first slot 120. In this illustrated arrangement, the first slot 120 and the second slot 130 are configured so that the mirror 700 can slide into the first slot 120 and the second slot 130. For example, the mirror 700 may be configured to removably slide into the first slot 120 and the second slot 130.

Different types of fastening systems and apparatus may be used for securing the mirror 700. For example, in one arrangement, the mobile device 10 may comprise a fastener configured to contain the mirror 700 on the housing 100. For example, in one arrangement, the fastener comprises a clip configured substantially perpendicular to the first slot 120 and the second slot 130. In another arrangement, the mirror 700 further comprises a hinged mechanism for hingedly coupling the mirror 700 to the housing 100.

In one alternative arrangement, the mobile device 10 further comprises a magnet for coupling the mirror 700 to the housing 100. In one arrangement, the mobile device 10 further comprises a suction device for coupling the mirror 700 to the housing 100.

With the disclosed systems and apparatus, different types of mirrors may be used. For example, in one arrangement, the mirror 700 may comprise a flex mirror.

A flex mirror is a type of reflective surface that is flexible and can be bent or shaped without breaking. This flexibility allows it to be integrated into various devices and surfaces, including smartphones. For example, flex mirrors may be made from a combination of reflective materials and flexible substrates, such as polymers or thin metal films. This combination allows the mirror to maintain its reflective properties while being bendable.

Despite being flexible, these mirrors can provide a clear and accurate reflection, similar to traditional glass mirrors. Flex mirrors are also designed to be durable and resistant to cracking or shattering, making them suitable for use in portable devices. The lightweight and flexible nature of the mirror makes it ideal for portable devices like smartphones. And unlike traditional glass mirrors, flex mirrors are less prone to breaking, making them more durable for everyday use. Moreover, the ability to bend and shape the mirror allows for innovative design possibilities and multifunctional uses.

In one arrangement, the mirror 700 comprises a polymer mirror. A polymer mirror comprises a type of reflective surface made from polymer materials, which are essentially large molecules composed of repeating structural units. These mirrors are designed to be lightweight, flexible, and durable, making them suitable for various applications, including integration into smartphone housings.

Polymer mirrors are typically made from high-quality plastic materials, such as acrylic or polycarbonate, which are coated with a reflective layer. This reflective layer can be made from metals like aluminum or silver, which provide the mirror-like finish.

In one arrangement, the mirror 700 comprises a mirrored film. A mirrored film comprises a thin, flexible sheet with a reflective surface, designed to mimic the properties of a traditional mirror. Mirrored films are typically made from high-quality plastic materials, such as polyester (PET) or polycarbonate, which are coated with a reflective metallic layer, often aluminum or silver. This coating gives the film its mirror-like properties.

In one arrangement, the mobile device 10 may further comprise an illuminating device configured along an outer surface of the housing 100. For example, in one arrangement, the illuminating device may be operatively configured to provide illumination to a surface of the mirror 700. One example of such an arrangement is that it would provide mobile device 10 users the ability to view the mirror 700 when in darkened areas or nighttime where sources of light might not be available.

In one arrangement, the mobile device 10 further comprising a cover. Such a cover may be configured to protect the mirror when the mirror 700 is not in use.

A cover designed to protect or conceal the mirror 700 on a smartphone 10 can offer several practical benefits. Here's a detailed description of how such a cover could be used and the advantages it provides:

Flip Cover: A flip cover can be designed with a flap that folds over the mirror when not in use. This flap can be easily opened or closed, providing quick access to the mirror

Sliding Cover: A sliding mechanism can be integrated into the smartphone case, allowing the user to slide a cover over the mirror when it's not needed and slide it back to reveal the mirror.

Snap-On Cover: A snap-on cover can be attached directly over the mirror area. This cover can be easily removed or reattached as needed.

Soft Silicone or TPU: These materials provide flexibility and shock absorption, protecting the mirror from scratches and impacts.

Hard Plastic or Metal: These materials offer robust protection and can be designed to match the aesthetic of the smartphone.

### Advantages of Using a Cover for the Mirror

Scratch Prevention: The cover protects the mirror from scratches and abrasions that can occur during everyday use, ensuring the reflective surface remains clear and functional.

Impact Resistance: A cover can absorb shocks and impacts, protecting the mirror from potential damage if the smartphone is dropped.

Concealment: When the mirror is not in use, the cover can conceal it, preventing unwanted reflections and maintaining the privacy of the user.

Seamless Design: A well-designed cover can blend seamlessly with the smartphone's overall design, maintaining its sleek appearance while providing additional functionality.

Customization: Covers can be customized with different colors, patterns, and materials, allowing users to personalize their devices.

Dust and Smudge Protection: The cover can protect the mirror from dust, fingerprints, and smudges, keeping it clean and ready for use

Multi-Functional Use: Some covers can be designed with additional features, such as card slots, kickstands, or even extra battery packs, enhancing the overall functionality of the smartphone.

Using a cover to protect or conceal the mirror on a smartphone offers several advantages, including protection from scratches and impacts, enhanced privacy, aesthetic appeal, improved hygiene, and added versatility. Whether through a flip cover, sliding mechanism, or snap-on design, these covers can ensure that the mirror remains in excellent condition while providing additional benefits to the user.

Each component illustrated in FIG. 4 works to create a cohesive and functional mobile device. The housing 100 protects the internal components, the display screen 200 provides visual output, the processor 300 manages operations, the memory 400 stores data, the communication module 600 enables connectivity, the input interface 500 allows user interaction, the power source 800 supplies energy, and the mirror 700 adds a unique utility feature. Together, these components ensure the device 10 operates efficiently and meets the user's needs.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A mobile device, comprising:
a housing configured to enclose and protect internal components;
a display screen mounted on the housing for presenting visual information to a user;
a processor disposed within the housing and operatively connected to the display screen, the processor configured to execute instructions and process data;
a memory operatively connected to the processor, the memory configured to store data and executable instructions;
a communication module operatively connected to the processor, the communication module configured to enable wireless communication with external devices;
an input interface operatively connected to the processor, the input interface configured to receive user inputs;
a power source disposed within the housing and operatively connected to the processor, the power source configured to supply electrical power to the mobile device; and
a mirror configured along an outer surface of the housing.

2. The mobile device of claim 1, wherein the housing comprises a friction fit for securing the mirror to the housing.

3. The mobile device of claim 2, wherein the friction fit of the housing removably secures the mirror to the housing.

4. The mobile device of claim 2, wherein the friction fit of the housing comprises a first slot and a second slot parallel to the first slot, the first slot and the second slot configured so that the mirror can slide into the first slot and the second slot.

5. The mobile device of claim 4, wherein the mirror is configured to removably slide into the first slot and the second slot.

6. The mobile device of claim 2, further comprising a fastener configured to contain the mirror on the housing.

7. The mobile device of claim 6, wherein the fastener comprises a clip configured substantially perpendicular to the first slot and the second slot.

8. The mobile device of claim 1, wherein the mirror further comprises a hinged mechanism for hingedly coupling the mirror to the housing.

9. The mobile device of claim 1, wherein the mirror comprises a flex mirror.

10. The mobile device of claim 9, wherein the flex mirror comprises a polymer mirror.

11. The mobile device of claim 1, wherein the mirror comprises a mirrored film.

12. The mobile device of claim 1, further comprising an illuminating device configured along an outer surface of the housing.

13. The mobile device of claim 12, wherein the illuminating device is operatively configured to provide illumination to a surface of the mirror.

14. The mobile device of claim 1, wherein the mobile device comprises a smartphone.

15. The mobile device of claim 1, wherein the mobile device comprises a mobile computing device.

16. The mobile device of claim 15, wherein the mobile computing device comprises a tablet computing device.

17. The mobile device of claim 1, further comprising a cover configured to protect the mirror when the mirror is not in use.

18. The mobile device of claim 1, wherein the housing comprises a front surface and a back surface, the back surface comprising a camera and the mirror.

19. The mobile device of claim 1, further comprising a magnet for coupling the mirror to the housing.

20. The mobile device of claim 1, further comprising a suction device for coupling the mirror to the housing.
